(19) United States
(12) Patent Application Publication
(10) Pub. No.: US 2006/0076744 A1
(43) Pub. Date: Apr. 13, 2006

(54) Versatile sorting cart

(76) Inventor: Linda Martin Martin, Oakland, CA (US)

Correspondence Address: Linda Martin, 1926 - 83rd Avenue, Oakland, CA, 94621, US

(21) Appl. No.: 10/964,112

(22) Filed: Oct. 12, 2004

(51) Int. Cl. B62B 3/00

(52) U.S. Cl. 280/47.35

(57) ABSTRACT

Versatile Sorting Cart is a unit comprised of (sections, shelves, bins, lids, drawer, tub, and handles) that facilitates performing multiple tasks concurrently, whereby it as a whole or representative parts comprise an environmentally adaptable sorting work activity center to collect, mark or code, deposit, extract, organize, track, store, exhibit, reuse, secure, recycle and transport select cargo in interior, exterior, transit, recreational, work, home, and other environments.

### BACKGROUND OF THE INVENTION

1. Field of the Invention

The presented invention pertains broadly to mobile storage unit for use in sorting, exchanging, stowing, marking, and transporting inventory. Prior art of moving carts with cargo containers produced no peers to Versatile Sorting Cart. More particularly, to moving carts with cargo containers. The unconventional features presented offers various ways in which it can be used as a working tool for sorting, a convenience by having adaptable stylish construction, is mobile, and offers at least eight storage arrangement and transport options.

2. Description of the Prior Art

Due to the unique features comprising the present embodiment search of prior art covered a wide range of carts. Review indicates carts with one or two primary features such as modular, and storage. Those termed modular or versatile were found to be limited in comparison to the presented embodiment. Specific purposed use was at times unspecified or limited. Prior art indicate extensive assembly in some presentations. Uses described were more singular such as for food, tool, computer, or books. Such assignment limited in comparison to the broad usage prescribed for the present embodiment. Search included the internet Rubbermaid site and the three thousand plus page Grainger Catalogue, as well as the following patents:

U.S. Pat. No. 5,205,620 describe a modular unit having shelves and drawers. Its construction has a focus on assembly and the “knock down” feature is emphasized.

D411,041 describe ornamental design for a food service cart with apparently recessed areas facing upwards, a door on the side and handles.

U.S. Pat. No. 6,398,235B1 describe a wheeled geared to apparently specified use

U.S. Pat. No. 6,247,769B1 describes a sizable moveable unit having shelves adjustable in depth and height.

U.S. Pat. No. 6,247,769 is titled Modular book/computer shelf moving cart named apparently according to intended use. See * Expanded Search

Wheeled units with shelves define many of the conventional carts. These may be solid or framed and constructed of wood, metal or plastics.

While prior art reflects a significant number of carts with wheels and shelves fewer have cargo containers. Still fewer carts or dollies have storage containers. The presented embodiment offers versatile storage containers

The current presentation is adaptable to hold cargo for performance of multiple task such tracking, recycling or to convey as part of a routine cycle.

Conventional carts without the restraints offer minimal stabilization of cargo. Cargo could easily destabilize during transport. The presented cart minimized the possibility for spillage and has handles to permit safety and ease in separating, lifting, and transporting.

Assembled carts comprised of a multitude of parts and roll on four wheels has not the option of tilting to aid in navigation. This cart is constructed to be sanitized by standard methods.

Carts primarily constructed with nuts and bolts or nails are susceptible to weakening at connection points. Preferred for the presented embodiment is nonporous plastic or polymeric material. Materials such as sheet plastic, sheet metal, wood or a combination would also be suitable.

The present embodiment requires a minimum of assembly. Lids and handles be attached in the presented embodiment. The base unit and cargo containers are intact without necessitating “knock down” or “build up” of primary base unit. There are a variety of features in the presented embodiment amenable to a great number of uses especially recycling. The subject cart takes space and environment into consideration and is intended to be unobtrusive and convenient.

The assignee has researched and applied the organizational needs of home, office, medical facilities, schools, and other settings constructing a novel compact, stable, versatile, mobile, and unobtrusive carting system requiring minimum assembly capable of appeal to a wide range of consumers

Versatile Sorting Cart is capable of the following terms applied in this application and not limited:

1. Recycle—cargo and/or containers optionally, selectively, and conveniently remain on/in the unit or selectively removed;

2. Multi Purpose—variety of uses;

3. Versatile*—features available for avaricious uses;

4. Modular—parts included for the possibility of select arrangement;

5. Transport—system allows cargo to move wholly or in part, base or container;

6. System—component parts, convenient, interactive.

* Versatile Sorting Cart is extensively versatile having cargo containers that mark and hold cargo, or other cargo containers which may be sealed or unsealed.

### SUMMARY OF THE INVENTION

At initial glance an observer might be in a quandary as to what the thing herein called Versatile Sorting Cart really is. The presented embodiment including shelves, containers, handles, hooks, wheels, cut out lids, sub lids, combo lids, depress lids, and hooks likely inspire curiosity.

The intent of this invention is to provide a cart comprising covered, uncovered and partially covered containers, secure on shelves with wheels that incorporates a method to concurrently mark, deposit, sort, stow, exhibit for reuse, or transport cargo for recycling in the home, office, shop, garage, work or outdoor sites.

An additional objective is to provide a versatile cart that serves several purposes concurrently as an organized system enabling the performance of a multiplicity of tasks such as manipulating, stowing, and transporting cargo, and which may or may not relate to recycling.

An objective of current presentation is a versatile cart capable of moving flat on four wheels or tilting on two wheels for extended maneuverability.

It is the intent of this invention to provide a R Versatile Sorting Cart on which containers are stabilized when the cart is in motion. The restraining strip bordering base first shelf and the insertion of the drawer into the base second section are stabilizing qualities.

Another object of a Versatile Sorting Cart presented herein is to provide a new type of storage unit capable of refining the deposit and recycling process for select types of cargo such as newspapers, cans, plastics, bottles, art supplies, or cafeteria waste conveniently.

Further, an objective of the presented storage and transport unit is to allow for the containment or removal of spoilage in a container without necessitating the moving of the whole cart.

A further object is to provide a versatile cart that remains useful although containers have been partially or completely removed.

A further intent is to provides a storage and transport unit sized to fit into standard work spaces such as among kitchen counters, tables, desks, isles, walkways merging easily in these settings. A Versatile Sorting Cart with limited protrusions I fit flush with other furnishings. A handle located approximately in the mid back area of unit allows it to be moved while seated, such as in a wheel chair.

The objectives includes providing a versatile cart with the qualities of a collective unit having capabilities for sorting, stowing, displaying, and transporting as primary factors. In the current embodiment of a wheeled cart and storage unit with marked cargo containers accomplishes these objectives. A base unit is free standing and associated containers, base lower drawer and insert may be arranged and manipulated for maximum service. Lids attach to the top of the base unit under the guiding handle area. Front facing handles are designed with hooked style enabling bags or items to be hung for convenience.

The current embodiment features four top styles having figurative cut out areas: circular, square, and diamond. The figurative cut outs marks or codes the container resting under the lid for assigned content should the option be selected. The option to used combo lids provided is a part ot the system.

Also, in the current embodiment lids may cover cargo bins with handles that are canisters elongated in height. The bins fit on the unit base first shelf securely between the back of the unit and the retaining strip running along the outer-most edge of the shelf. Tops attached to the base unit are lifted to remove a bin, conversely, the lid is lifted to replace the bin on the base first shelf. These lids are constructed with a front lip downward at right angle to grip the bin to hold in place. A secondary restraining strip rest along the bottom of the slanted section for convenience.

In a preferred embodiment, the base is constructed of material gauged in the plastic or manufacturing industry to endure weight of what is contained, stowed, or transported, and which will maintain its shape after prolonged use. The dropped slant extended downward from the retaining strip running the width of the base unit assist in strengthening the unit, and closes a portion of the base lower section shelf space at the outer most front.

The downward angle contributes to the attribute of merging easily with the environment and eliminates sharp points as these could cause injury to the body, especially at the leg area, a safety factor. Also, the slanted plane prevents accumulation of what might obstruct base first shelf bins.

Capability to add locking hardware to lids and base drawer has been addressed in the preferred presentation. Base upper shelf bin height is sized to also fit into base lower shelf pocket, adding convenience. A handle reaching from the right to left extreme top of base member fit a gamut of hand sizes. In the back of the base member is a convenience handle to accommodate persons with disabilities, who must sit, or short of statue.

The drawer accommodates up to six one-gallon jugs in the current embodiment the cart drawer may be converted into two compartments by inserting the tub.

The Versatile Sorting Cart containers are distinctively sized to the dimensions of commonly used packages including cans, bottles, newspapers, bags, and other. When selected at least seven (17) entry and withdrawal portals are available in the unit at one time: three (3) on the tip shelf, two (2) on the slant hood, and two (2) in the base bottom section. Handles with hooks and restraining strips pose additional options.

There is a need for a cart with features beyond the tradition of only supporting and transporting items. The service/recycling cart is a great leap ahead by increasing usage options to include enhanced sorting processing, stowage, transport, and meeting the ecological demands of modern everyday life where items are recycled, or reused on site, therefore reducing waste.

### BRIEF DESCRIPTIONS OF THE FIGURES

Versatile Sortinq Cart

FIG. 1 is a Recycle And Multi-purpose Cart perspective view.

FIG. 2 is a crrss sectional view base member with bins and drawer.

FIG. 3. is a right and frontal view of base with restraining strips.

FIG. 4. is a sectional view of base back and sides

FIG. 5. is a perspective view of bins with bag grip.

FIG. 6 is aag grip mage magnified.

FIG. 7. is a perspective view of base drawer.

FIG. 8. is a frontal view of open drawer and bins.

FIG. 9 is a top frontal view of bins with combo (closed) lids.

FIG. 10 a-c are top views of figurative cut out lids.

FIG. 11 a-c are under views of cut out lid and braces for sub lid.

FIG. 12 a-c are views of sub lid braces and fitting.

FIG. 13 a-d are views of base upper frontal lid rod and lid.

FIG. 14 a-d are views of depress lid and latch.

FIG. 15 a-c are side vertical, frontal and horizontal view of hook and handle.

FIG. 16 a—are views of base back mobility handle.

FIG. 17 is a view of tub within base.

FIG. 18 is a cross sectional view six gallon size containers in drawer.

FIG. 19 is a bin shown resting in bottom section

FIG. 20 is a bas resting on hook handle.

FIG. 21 is a frontal view of unit with object restrained on slant.

### DETAILED DESCRIPTION OF THE EXEMPLARY EMBODIMENTS

The present invention has the intent and objective as a versatile storage cart especially adapted to include conveniently organizing, sorting, and transporting assorted items including recycling in the home, office, transit, school, restaurant, recreation, or work place.

Versatile Sorting Cart is adaptable for use in a variety of settings such as the kitchen, shop, garage, lab, classroom or to gain to benefit of salvaging reusable raw material thrown away in transit or waiting-room locations. For example, the embodiment presented herein may be useful for placing empty containers such as food and soda cans, plastic bags, newspapers, milk or juice jugs, and trash or food wrappings.

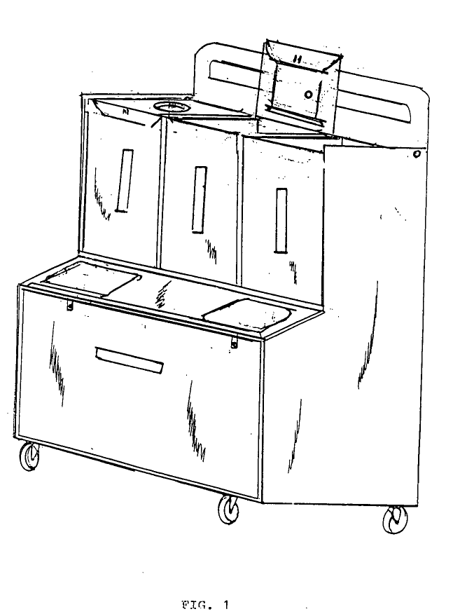

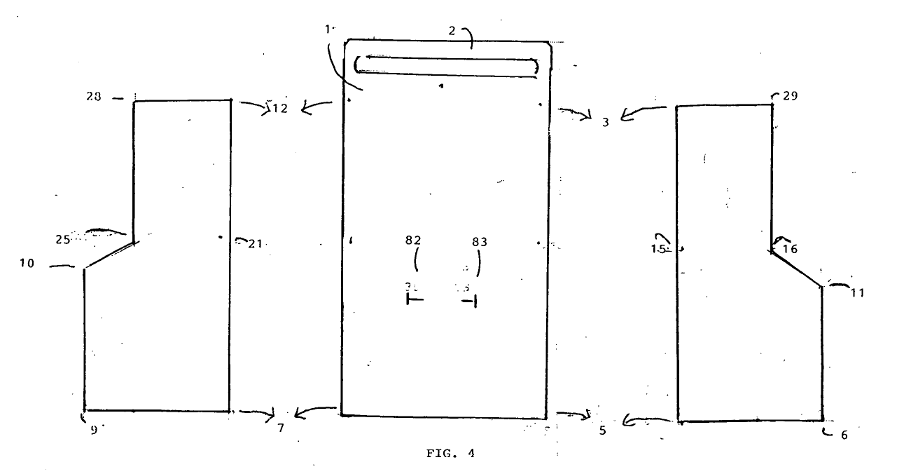

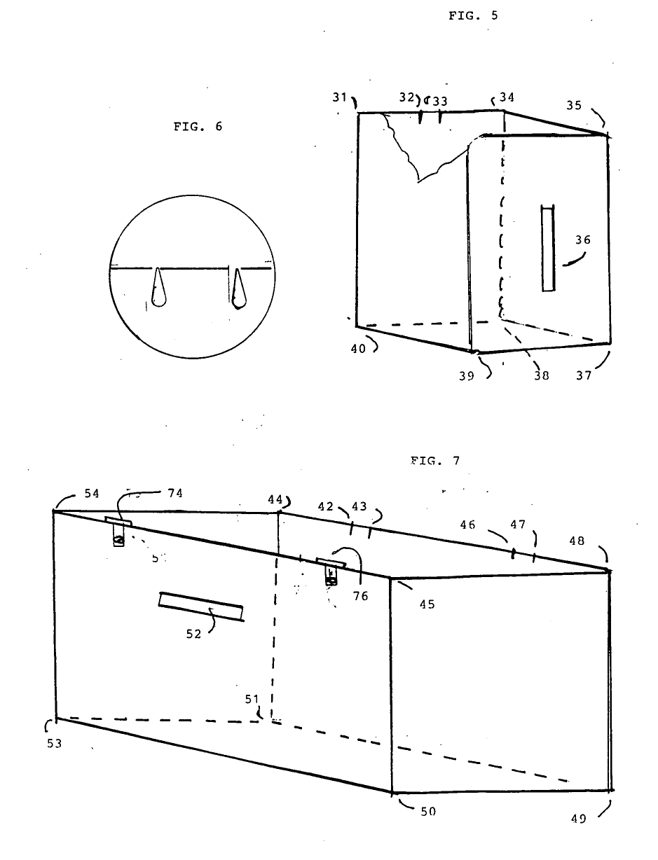

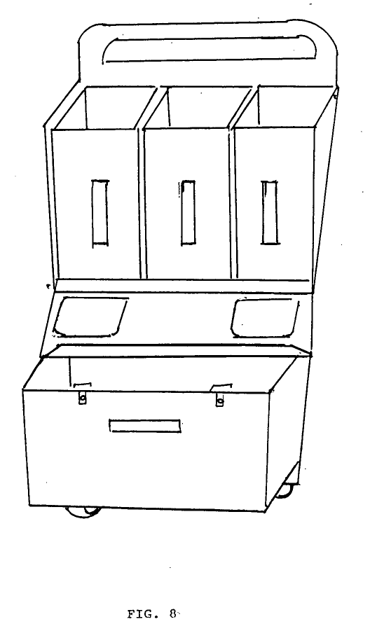

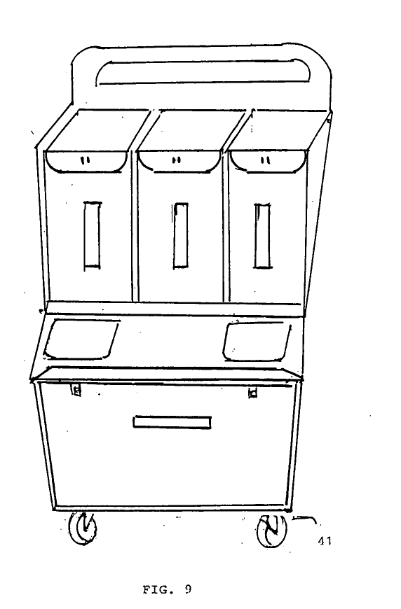

More broadly, the versatile unit may be used to display and stow a particular category of items such as underwear, tools or toys. Thus, the present invention is adaptable to hold a variety of other uses for extended or temporary periods and easily roll flat or tilted to indoor or exterior destinations. FIGS. 1 through 18 and claims 1 through 18 represent the unique and unprecedented Versatile Sorting Cart.

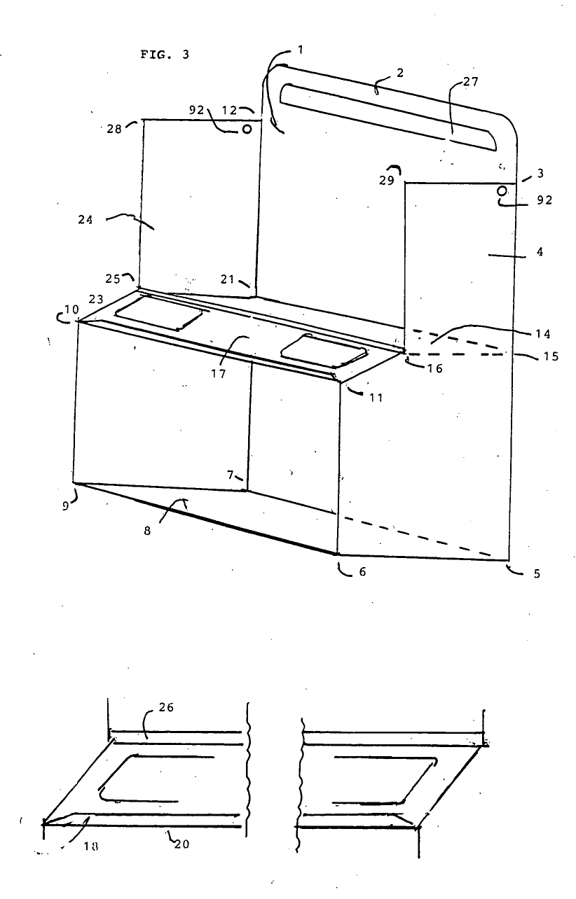

Referring generally to FIG. 1, Versatile Sorting Cart is shown in an upright position, described in claims 2 and 3, that rest on four attached wheels. The unit includes a base FIG. 3 that in the present embodiment is suitable to molding. Planes and figurative components may also be assembled and sealed.

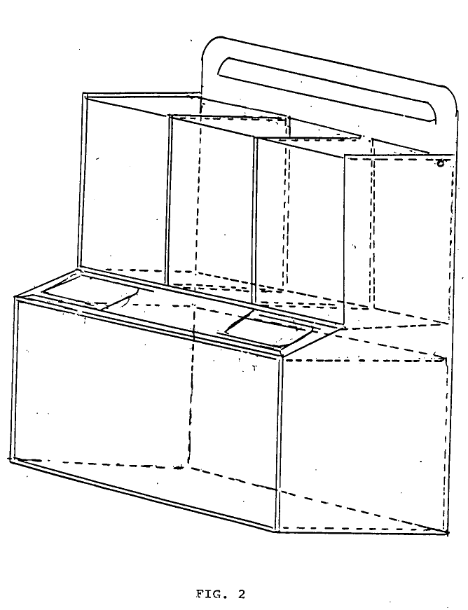

FIG. 2 shows a cross sectional view of the base member and base cargo containers.

The base member FIG. 3a is comprised of right side 4 and left side 24 connected vertically to the back 1 at right angle between points 5 & 3 and 7 & 12. Handle 2 is formed at the uppermost top of base back 1. Two base sections are formed in the presented embodiment.

Base first section illustrated in FIG. 3 a/b comprises planes 4,14, 24,29,

Base second section borders are 4, 24, 14, 17, with 8 being the bottom. Across the top front of base second section is slant hood 17. Cut into slant hood 17 are openings for depress lids 21 and 23. Base second section may be used with or without cargo containers.

Two restraining strips 18 and 26 assist in stabilizing items or cargo containers, claim 3 e/n. Strip 26 extends from points 16 to 25 a barrier behind which cargo contains on base first shelf sit preventing their falling off especially when in transit. Strip 8 extends from points 10 to 11.

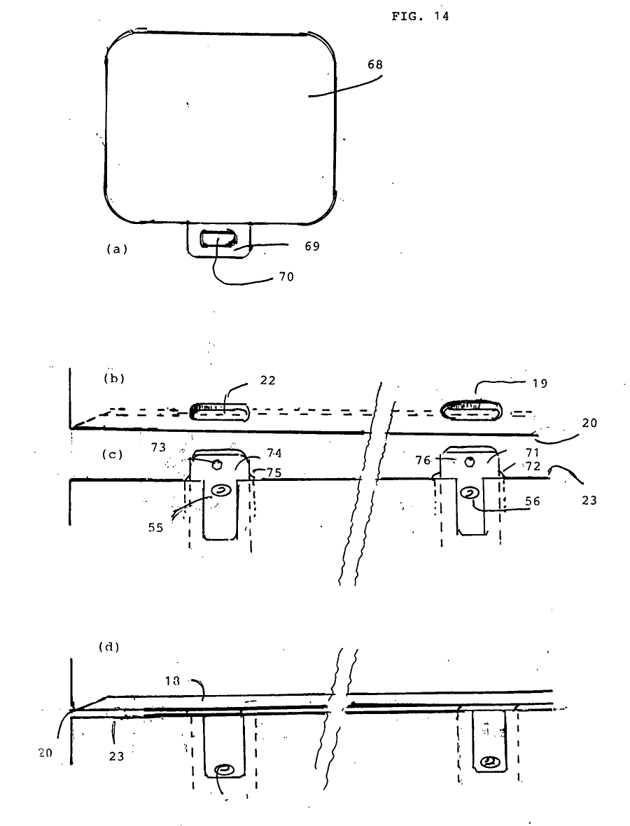

Two pairs of openings appear in the presented embodiment. Rod openings 92 and 93 are located on the right and left side panels near the top back corner 12 and 3, FIG. 13ab. Latch openings are located on the right and left side of the slant hood 17 behind restraining strip 8, FIG. 14b. See claim 3 l/m.

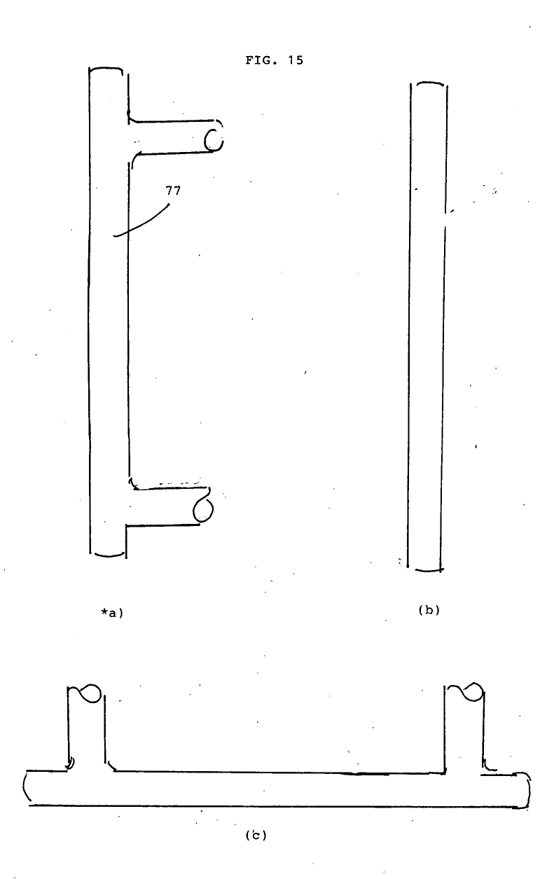

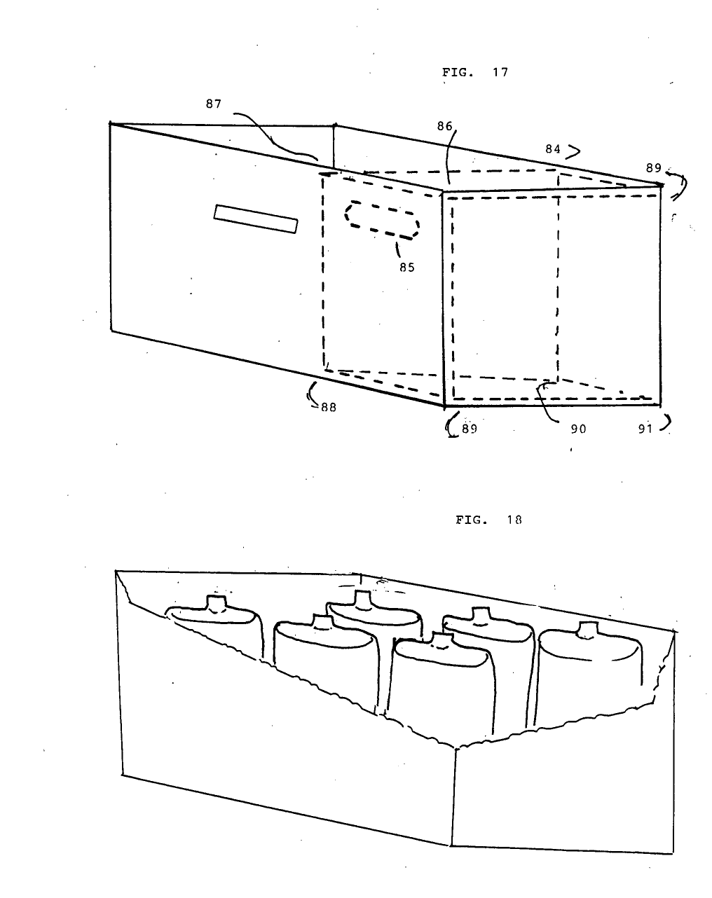

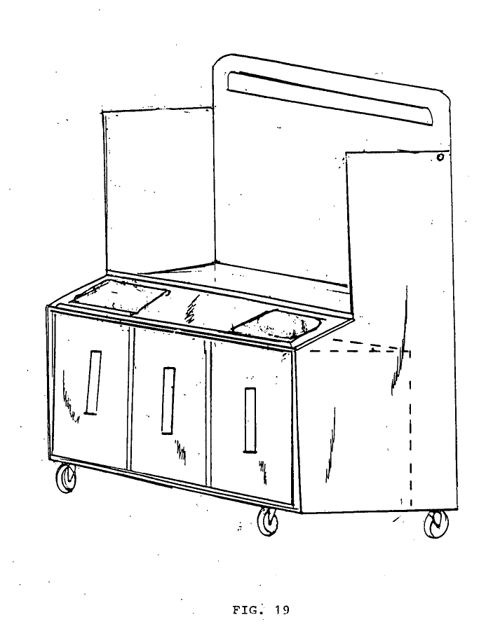

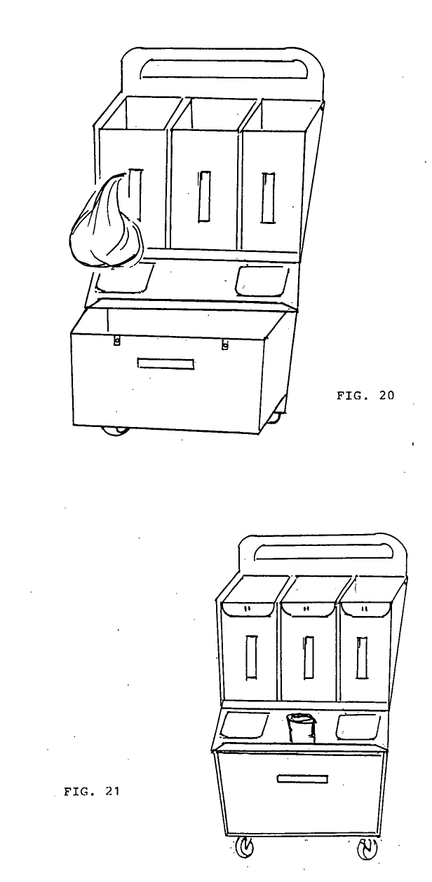

Versatile Sorting Cart includes four types of cargo containers, namely, base bin FIG. 5, base drawer FIGS. 7 and 17, and base tub FIG. 17. Incorporated in base bin and base drawer handles is also a hook. FIGS. 15 a/b/c, adding the potential to hang a bag or object. See base tub 85.

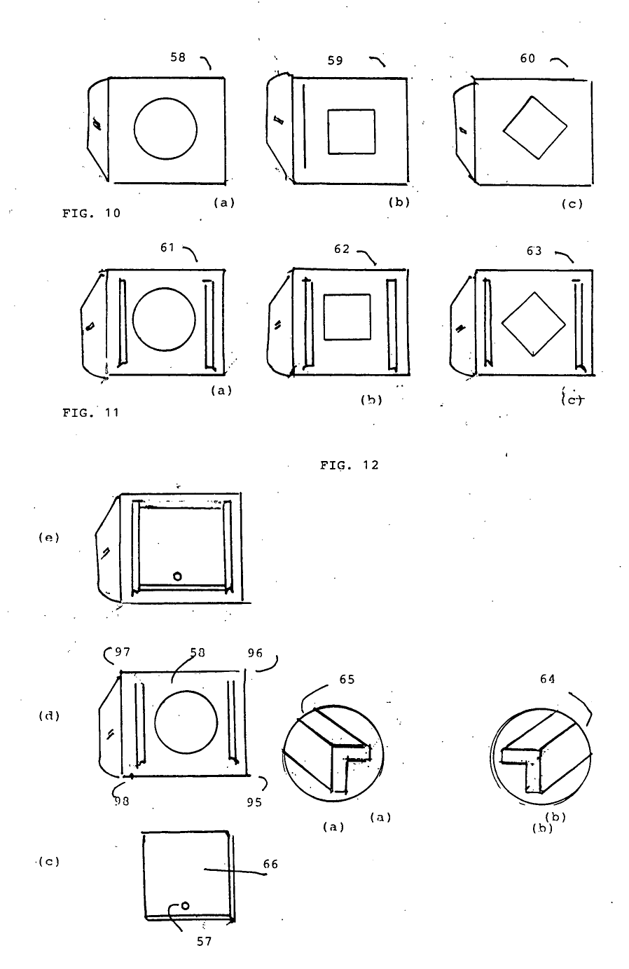

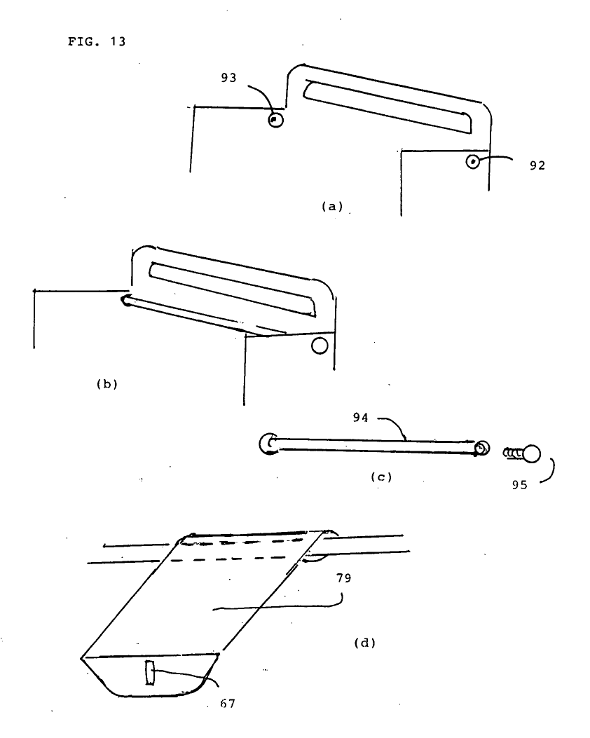

Versatile Sorting Cart includes four types of lids, cut out lid FIGS. 10a/b/c and 11 a/b/c, sub lid FIGS. 12 c/d/e/66, combo lid representation 79 (a combination of the first two) and depress lid 83, FIGS. 14 & 68. See claims 4 and 5.

Cut out lids attach to the base member by inserting rod 94 through the tubular back of the lid illustrated FIGS. 13 a/b/c/d and securing it with a bolt 95. See lid FIG. 13d. On the front edge of the lid is a lip that also assists in stabilizing the containers during transit, claim 4 h.

Sub-lid slides in tracks 64 and 65 located underneath cut out lid forming a solid combo lid 79 to cover a bin. The closed lid may or may not represent a code or mark. Sub lids may match the bin member in color or be any selection from the color wheel, in the presented embodiment.

The depress lid is FIG. 14a is held by hinge (unshown) in openings 21 and 23 depresses when pushed by the hand or an object.

The potential for locking is built into both cut out lid (also modified combo lid) at placement 67, FIG. 13. Depress lid has opening 70 in the front area to accommodate latching hardware, claim 6. Cut out and sub lid have opening 67 to accommodate locking hardware. Two depress lid latch openings 19 and 22 are located on the right and left side of the slant hood 17 behind restraining strip 8 through which a latch FIGS. 14 b/c/d extending from base drawer may be raised or lowered. The latch presented herein or a facsimile may be used without diminishing the protection provided in this claim.

Cut out lid and sub lid combine to form a minimum of 17 bin and lid adaptations. The addition of color expands the possibilities very notably.

Versatile Sorting Cart is heretofore not presented in prior art. This multi-purpose versatile cart is very useful in its basic and most complex organizations.

Should a user to select, the entire unit or various component parts may be assigned a code or mark identification for select use. See claims 8 and 9.

For example 59 and 62, FIGS. 10 and 11, is a base lid cover with a figure cut out in the top in the shape of a square. Other figurative openings represented in this application is the “circle” 58 and 61 and “diamond” 60 and 63. The figurative opening allows the user of the cart to select, reserve, and identify the unit sections, or containers for assigned item management such as type of kitchen waste, or recycled items.

FIG. 11 representation 59 is a versatile storage unit bin cover with a cut out opening mark in the top in the shape of a square. The mark, opening allow user to select use of cargo container over which it rest for insertion or extraction of selected class, type of item, matter, waste, or recyclable. In addition, marking may include the use of color. Alternatively, differentiated figurative openings imply marking as part of this invention. Alternatively, differentiated textures or material composition.

Bin handle may be molded or cut into bin and is hereto included in protection. Handles forming hooks for hanging objects such as bag attach to the base unit with screws (unshown). Handles may be molded without departing from this claim.

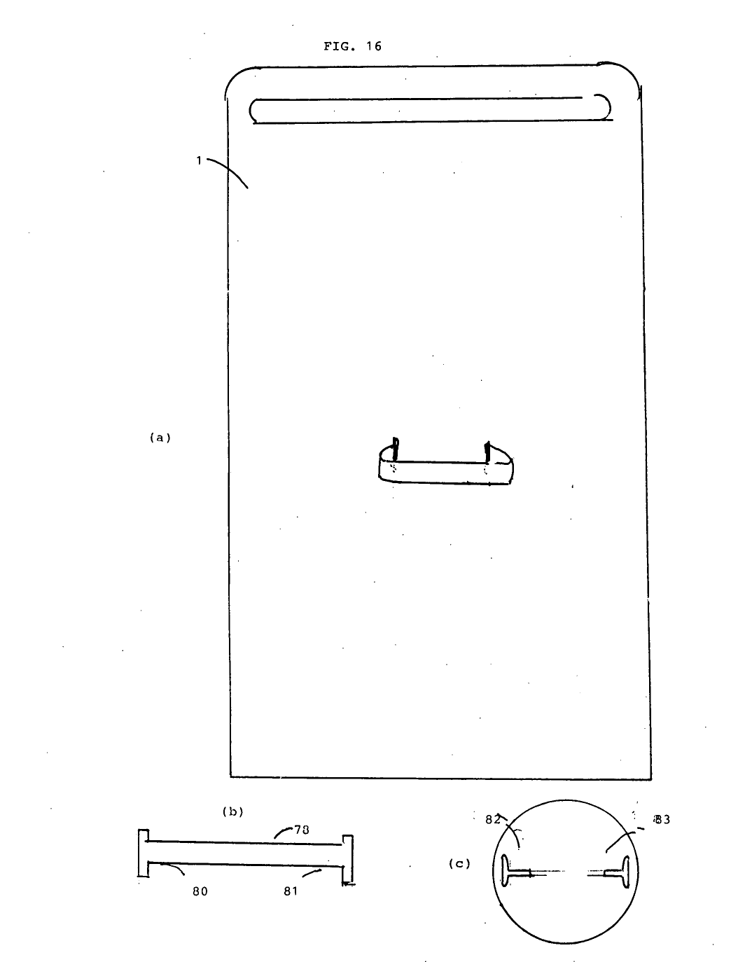

A mobility handle FIG. 16 ends 80 and 81 fit respectively into slots 82 and 83 cut into base back 1. The handicapped or individuals of low height can therefore use this handle.

Figurative cut-outs, style of mobility handle, shape or size of shelves and cargo container, wheels or casters may be selected or preferred without significantly changing the protected aspects of the cart for the purpose of this invention.

As stated, alluded to, and is obvious numerous variations, modifications are feasible in keeping with the present presentation and representations. The invention presented may comprise a selection of shapes and sizes and be constructed out of material selected by a manufacturer and will not exceed the scope of the present invention.

Also, this invention includes adjustments in the number, size, location of cargo containers and shelves.

The Cart invention described and illustrated herewith presents the versatile qualities of a unique and heretofore unrevealed cart and request claim.

Important objectives include simplifying the recycling process where focus on household and community recycling is a relatively new concept. Another has been to replace cumbersome assortments of boxes, bags, and buckets currently in use with a neat and consolidated system, namely, Versatile Sorting art. This refined alternative for which claim is requested might possibly increase participation in recycling tremendously.

In reference to prior art, and claims, modifications or changes made to the exemplary presentation of the present invention will be cohesively maintained without departing from the inventive concepts for which protection is granted herein.

I claim:

1. A Versatile Sorting Cart adapted for use to concurrently, insert, extract, organize, track, collect, stow, exhibit, reuse, mark, transport, and recycle selected cargo, comprising;

2. A Versatile Sorting Cart wherein base member, sections, cargo containers, cut out lids, combo lids, sub lid, depress lids, container bins tub and drawer are included for use and may each represent individually or wholly a mark or code indicator for selected use;
a. At least one base member;
b. At least one base section member;
c. At least one base shelf member;
d. At least one base bin member;
e. At least one base drawer member;
f. At least one base tub member;
g. At least one base lid member;
h. At least one base hook handle;
i. At least one handle; on back of base;
j. At least one base member consisting of at least one base shelf;
k. At least one base member consisting of at least one base shelf and one container; and
l. At least one base member consisting of at least one base shelf and one contain with wheels underneath.

3. A Versatile Sorting Cart with a base member having a combination of sections, shelves, cargo containers, figuratively cut out lids, sib lids, combo lids, depress lids, drawer, tub, base guiding handle, hook handles, restraining strips, and wheels;
a. An upright base member having at least one base first shelf as bottom of base upper section;
b. An upright base member having at least one base second shelf as bottom of base lower section;
c. A base member according to the presented embodiment consist of attached rectangular planes, namely, base bottom, base first shelf, base second shelf, base back up to the handle, slanted hood, and right and left side members above and below where the slant hood is attached. Right and left side members are greater in depth below than the portion located above the slant hood. Hood slant fits to the angled portion of the side members;
d. A base upper section having a rectangular flat bottom identified as base first shelf joined at extreme right and left at right angles to two vertical base left and right side members leaving an open top and front, bottoming forming the inner most top to base lower section;
e. A base first shelf having a restraining strip running along the front open bottom edge of base upper section from extreme right to extreme left;
f. A slanted rectangular plane extended downward from the entire length of the drawer restraining strip identified as slant hood;
g. A base lower section storage area having a rectangular flat bottom joined at extreme right and left at right angle to the wider in depth potion of vertically standing base right and left side members;
h. A base lower section wherein the base drawer member may be inserted;
i. A base member having at least one pair of holes, one on the right and another on the left upper most area of base side members, to attach base lid support rod;
j. A base member wherein the bins may be optionally inserted in base lower section;
k. A base second shelf is the extreme bottom of the base member;
l. A preferred unit where surfaces intersect, sides, back, bottom, top shelves, bottom shelf, and slanted hood;
m. A base member having at least one hole cut into the slant hood where a depress lid is attaches;
n. A versatile cart adapted for rolling flat on four wheels;
o. A base member having at least one hole into which latching hardware may be raised, located behind slant hood restraining strip;
p. A restraining strip across bottom of slanted rectangular plane;
q. A tub member that fit inside the base drawer;
r. A bare member extending from base interior sides on which base lids hinge; and
s. A base member having wheels bolted or otherwise connected underneath (ushown).

4. At least one bin with the capacity to remain completely uncovered having no lid;
a. At least one lid having the capacity to be closed;
b. At least one lid having a figurative cut-out;
c. At least one cut-out lid having a pair of braces on the underside with the capacity to hold in place a sub-lid to optionally fill the opening;
d. At least one sub-lid to close a cut-out lid;
e. At least one sub-lid in a color in contrast to the color of the cut-out lid;
f. At least on cut-out lid having a frontal downward sloping lip in which there is an opening for optionally attaching locking hardware;
g. At least one modified combo lid formed by combining sub lid and cut out lid; and
h. At least one cut out lid having the capacity to be hinged to the base member.

5. At least one depress lid that depresses moving downward when an object is inserted through it to the opening underneath;
a. At least one depress lid located on the slant hood above the base drawer;
b. At least one depress lid located above the space not occupied by the tub; and
c. At least one depress lid hinged to opening in slant hood.

6. At least one depress lid having the capacity to be locked;
a. At least one depress lid having an opening in the frontal area through which a locking mechanism may be inserted;
b. At least one latch-opening located behind slant hood restraining strip through which a latch protrusion may be raised or lowered; and
c. A latch attached to the front uppermost area on the base drawer's right ad left underneath latch openings on slant hood.

7. A Versatile Sorting Cart that may hold at least one container capable of containing another select container.

8. A Versatile Sorting Cart wherein base member, sections, cargo containers, and lids may collectively be used as visual sign or mark indicating assignment of a select use;
a. A base member without one marked cargo container;
b. A base member with at least one marked cargo container;
c. A cart with at least one container having an accessible opening and wheels;
d. At least one cargo container with an accessible opening;
e. At least one cargo container member with one marked lid cover;
f. At least one cargo container member marked with a combo lid cover;
g. At least one cargo container having a lid cover with interior cutout mark;
h. At least one cargo bin with a handle; and
i. A handle attached to the cargo drawer;

9. A Versatile Sorting Cart adaptable for use as a collective unit to marks representing select standards of actions may be assigned to deposit, organize, stow, identify, collect, exhibit, transport, and reuse selected cargo as in recycling;
a. A Versatile Sorting Cart wherein cart base member, sections, shelves, cargo containers, combo lids, cut out lids, and depress lids may each represent a mark, code, or indicator for select usage;
b. A base member having at least one hinged and detachable base lid marked by figurative, geometric cut out as selected code or mark;
c. A base member having at least one hinged and detachable base lid coded by not having an interior cut out figure closed with a sub llid;
d. At least one hinged and detachable base lid marked by color or select means;
e. At least one detachable lid coded by sliding underneath it a sub lid of contrasting color;
f. A marked base member consisting of at least one marked base shelf, container, lid, and having handles and wheels; and
g. At least one base member on wheels consisting of at least one base shelf, one container, one handle, marked by color, transparency, positioning, or other selection.

10. A Versatile Sorting Cart constructed as a consolidated system for ease in organizing, depositing, exhibiting, withdrawing, stowing, coding and transporting goods for use in residents, offices, work, transit and outdoor sites;
a. A versatile cart wherein at least one section provides storage and access for the selective removal or deposit of cargo or container;
b. A versatile cart wherein a plurality of sections provides storage and access for the selective deposit, permanent removal or removal for reuse of cargo or container;
c. A versatile cart wherein at least one cargo container can be removed or deposited;
d. A rectangular plane extend downward beyond base first shelf having at least one opening covered by a depress lid; and
e. A downward slanted rectangular plane lending safety by avoiding sharp angles.

11. A compatible construction for ease of fit in select setting.

12. At least one lid cut out in the interior in the shape of a select symbol for identifying selected use.

13. At least one lid with a figure cut out in the interior as a select symbol for identifying selected cargo;
a. At least one lid having a select figurative cut out interior may be removed; and
b. Where there may selectively be no lid cover on a bin.

14. A drawer when partially inserted in the base lower section is a coded opening for insertion or extraction of select matter.

15. A base first shelf sized to securely hold the number of bins in the presented model.

17. A versatile cart preferably made of washable material for ease of sanitizing.

18. A multipurpose consolidated system for depositing extracting, exhibiting for reuse, stowing, marking, and transporting.
